(19) United States
(12) Patent Application Publication
(10) Pub. No.: US 2008/0123948 A1
(43) Pub. Date: May 29, 2008

(54) Profile creation configuration file

(75) Inventor: Dirk C. De Baer, Berchem (BE)

Correspondence Address: BREINER & BREINER, L.L.C., P.O. BOX 320160, ALEXANDRIA, VA, 22320-0160, US

(73) Assignee: Monotype Imaging, Inc., Woburn, MA (US)

(21) Appl. No.: 11/605,256

(22) Filed: Nov. 29, 2006

(51) Int. Cl. G06K 9/00

(52) U.S. Cl. 382/167

(57) ABSTRACT

An apparatus, computer product and method for configuring a color management system profile used to gamut map image data to the gamut capabilities of an output device is disclosed. The method executes the steps of deriving a first look-up table that is used to convert a device-dependent color space into a device-independent color space, creating an object list including a plurality of objects, wherein the object list is interpreted by a computer application with reference to a configuration object to generate a second look-up table that is used to convert the device-independent color space into a different set of values within the same device-independent color space, storing the second look-up table, configuring a profile that accesses the second look-up table, wherein the configured profile is associated with an output device, performing gamut mapping using the associated, configured profile on the image data, and outputting the gamut mapped image data to an output device.

### FIELD OF THE INVENTION

Disclosed is a system and method for image processing, in particular, for the generation of a color profile.

### BACKGROUND

In a color management system, a color profile describes the color characteristics of a particular device or color space. The color profile is used in converting color image data from a device-independent color space to a device-dependent color space or vice versa. Devices such as monitors, printers, cameras and scanners typically have color profiles associated therewith. These devices typically have one profile.

Color profiles provide a computer's color management system (CMS) with the information necessary to convert color image data from device-dependent color spaces, such as CMYK or RGB, to device-independent color spaces, such as CIE XYZ or CIE LAB. Referring to FIG. 1, a computer application 100 provides parameter data to a color management system 120, a graphics library 125 and imaging library 127. The parameter data includes, along with other information, the specifications for outputting image data according to the computer application 100. Based on the color profile 130 and the parameter data, the color management module (CMM), be it the default operating systems CMM 123, or third-party CMMs, 126 and 128, performs color gamut mapping.

A profile 130 has a particular structure that is specified in International Color Consortium (ICC) standards, such as ICC 1:2004-10, which is available on the World Wide Web at color.org. The profile structure is defined in the ICC standard as a header followed by a tag table followed by a series of tagged elements that can be accessed randomly and individually. The collection of tagged elements provides three levels of information for developers: required data, optional data and private data.

Within each profile is an additional parameter that can be set depending on the intent of the user, which is usually based on the manner the image will be used. This is called rendering intent, of which there are four types. Typically, each of the conversions useable in the profile configuration file corresponds to a specific rendering intent.

The four types of rendering intent are the relative colorimetric, absolute colorimetric, perceptual, and saturation. The absolute colorimetric rendering intent, for instance, is typically used to calibrate a particular device. When a user wants colors to be bright and to stand out, for instance, when outputting a presentation or in an advertisement, then the rendering intent would be set to the saturation setting. However, a printer is always limited to only the output results that it is capable of producing. A printer's saturation rendering intent provided by the printer's profile may not be capable of producing the amount of saturation desired by the user.

To overcome this deficiency, several products have been developed that enable users to either create or adjust device profiles. These packages have substantially the same procedures for creating or adjusting the profiles.

To generate a device color profile, typically, a color test pattern must be printed by the output device for which the new color profile will be generated. The colors in the color test pattern are measured by a colorimeter, for instance. The CMYK values from the output device including the measurement values are obtained, and the output device is modeled. The model is used to translate the device color space, i.e., the CMYK values, to a device-independent color space, such as CIE LUV. The adjustments available in profile creation software are typically directed to meeting the requirements of a specific type of output device, such as an inkjet printer, a thermal transfer printer or a laser printer. To create more adjustments to these different profiles, the software implementing the adjusted device profile typically must be recompiled to new parameters desired by a user. To the user, only minor gamut mapping adjustments are available. Therefore, the above-described packages available from companies such as X-rite, Kodak, Fuji/Xerox and Agfa, are limited in the extent of gamut mapping that a consumer can perform.

On the other end of the spectrum are professional profile software applications that allow professional color specialists to alter color profiles. However, to make proper adjustments to the profile, a user must have extensive knowledge of color management systems and gamut mapping, and the process requires a substantial amount of trial and error to achieve the user's desired results. Furthermore, users must print many samples and verify the outcome of each and every change of the configuration file affecting the device profile. This results in a large amount of wasted time as well as resources.

### SUMMARY

Disclosed is a method for configuring a color management system profile used to map image data to the gamut capabilities of an output device. The method executes the steps of deriving a first look-up table that is used to map color values in a device-dependent color space to color values in a device-independent color space. An object list is created comprising a plurality of objects, wherein the object list is interpreted by a computer application with reference to a configuration object to generate a second look-up table. The second look-up table is used to map the colors in the device-independent color space into a different set of values within the same device-independent color space. The second look-up table is stored in memory. A profile is configured by accessing the second look-up table, wherein the configured profile is associated with an output device. The image data is gamut mapped according to the configured profile associated to the output device, and is transmitted to the output device for output.

Also disclosed is a computer product stored on a computer-readable medium for configuring a color management system profile used to gamut map image data to the gamut capabilities of an output device. The computer product causes a computer to perform the steps of the disclosed method.

Further disclosed is an apparatus for configuring a color management system profile used to gamut map image data to the gamut capabilities of an output device including a means for deriving a first look-up table that is used to convert a first device-dependent color space into a device-independent color space. The apparatus has a means for creating, based on input from a user, an object list comprising a plurality of objects, wherein the object list is interpreted by a computer application with reference to a configuration object to generate a second look-up table that is used to convert the device-independent color space into a different set of values within the same device-independent color space. A storage means for storing the second look-up table is also provided. A profile is configured by a means for configuring a profile that accesses the second look-up table, wherein the configured profile is associated with an output device. Gamut mapped image data, which is gamut mapped according to the associated, configured profile, is transmitted to an output device.

### BRIEF DESCRIPTION OF THE FIGURES

Exemplary embodiments of the disclosed system and method will be described in more detail with reference to the following drawings:

FIG. 1 illustrates an exemplary color management architecture;

FIG. 2 illustrates an example of a gamut mapping process;

FIG. 3 illustrates a rudimentary gamut mapping system and an overall process flow diagram;

FIG. 4 illustrates an exemplary process for creating an exemplary look-up table used in a device profile according to an exemplary embodiment of the present invention;

FIG. 5 shows an exemplary data structure of a procedure used to implement an exemplary embodiment of the present invention;

FIGS. 6A-6E illustrate the exemplary conceptual data structure of a procedure used to create the profile and look-up table according to an exemplary embodiment of the present invention; and

FIG. 7 illustrates a system for implementing an exemplary process for creating an exemplary look-up table used in a device profile.

### DETAILED DESCRIPTION

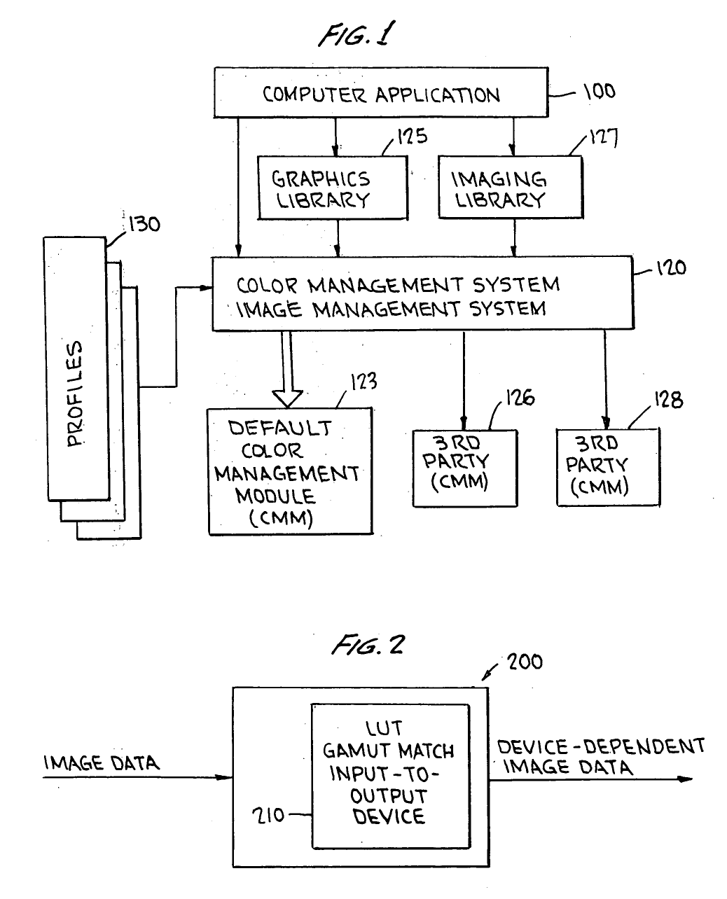

Referring back to FIG. 1, embodiments of the present invention allow a user to generate device profiles, such as profiles 130, in order to create user-specified look-up tables to perform color matching. To obtain a customized appearance to an output document, a user may desire to alter the profile of the user's specified output device.

As shown in the basic example of FIG. 2, image data is obtained by a computer application, such as computer application 100 of FIG. 1, for output to a specific output device. The computer application accesses a profile associated with the specified output device. The profile contains a look-up table 210, that is used to gamut map the image color data values from the image color space to the device color space. In other words, the image data, which is in one color space, is mapped to a device-dependent color space according to the look-up table 210, or LUT. Often, image data values in the image color space are mapped to an intermediary color space called the profile connection space (PCS). From the PCS, the data values are mapped to a device-dependent color space.

A goal of the gamut mapping is to derive lookup-tables for each of the four rendering intents, in order to convert PCS values into device color space values. The profile connection space is a device independent color space, such as CIE LAB or CIE XYZ color spaces.

Using the derived look-up tables, the image data can then be gamut mapped for any selected rendering intent using a profile connection space to a device color space look-up table.

The internal workflow within the color management system library for gamut mapping starts when setting up the lookup-tables for the different rendering intents. At this point, typically, the characterization of the output device has been completed, and a device-to-profile connection space (PCS) for the absolute rendering intent is available. Also available is a single configuration object. This configuration object is a “layout object”. The layout object is a user selected .lay file with additional data given by the user to control the profile creation. The configuration object is a computer file that is a collection of all the parameters, including the layout object, that are used to create an output device profile, such as test chart data, gamut mapping configuration file data, look-up table size (e.g., an interpolation table having dimensions such as 17×17×17, 33×33×33, the varying size provides varied resolution), total ink values, black ink values, and the like.

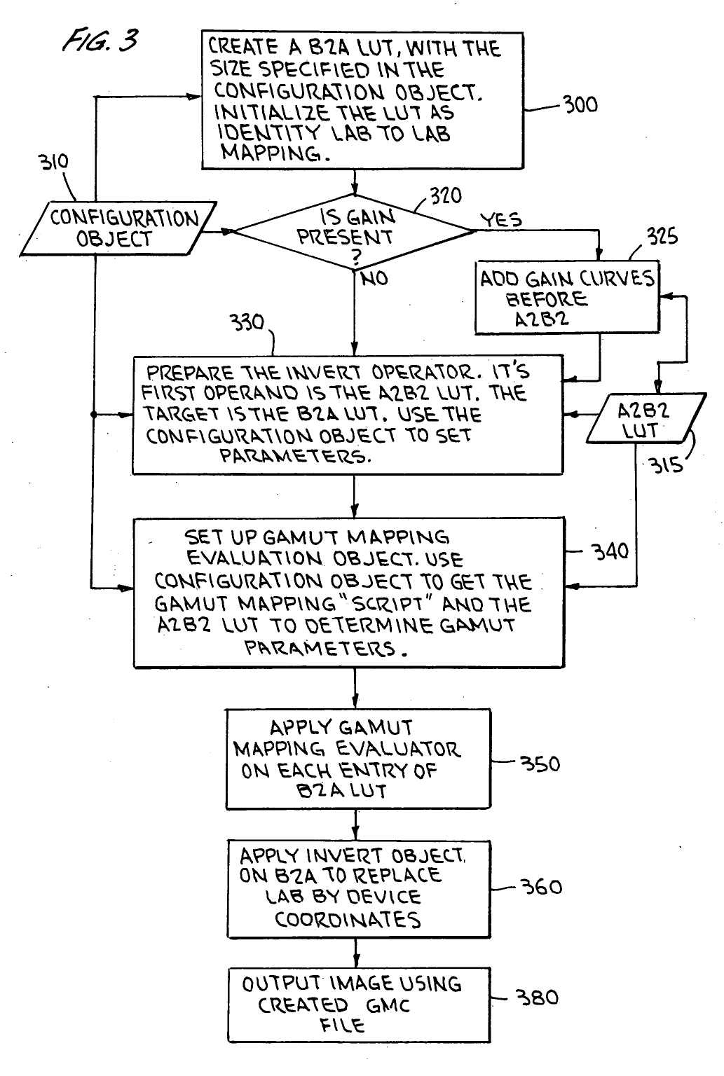

As shown in FIG. 3, a first step, step 300, is to initialize with values a device independent to device dependent look-up tables (B2A LUT), with the size specified in the configuration object. The look-up table is initialized as an identity in L*a*b to L*a*b mapping, meaning that the look-up table is actually an interpolation table. Using the look-up table, interpolation of color image data from, for instance, L*a*b color space to CMYK color space can be performed.

The look-up table (LUT), the size of which is defined by the number of interpolation points, typically, are arranged in matrices with sizes, such as 17×17×17, 33×33×33, and are based on the configuration object. The configuration object 310 is accessed to determine if gain is present at step 320. If gain is determined to be present gain curves are added to the B2A LUT, at step 325, before the absolute colorimetric (A2B2) LUT 315 is applied to prepare the invert operator in step 330. The A2B2 LUT 315 is obtained from measurements of print test patterns by colorimetric measuring devices to determine the gamut of the device. The B2A LUT is generated so the device-independent mapping parameters can be established in an independent color space, such as CIE L*a*b.

Using the values initially input into the B2A look-up table and the absolute colorimetric look-up table 315, an invert operator is created using the configuration object to set parameters (step 330). The invert operator (A2B) is output to process step 140, where the gamut mapping evaluation object is set up.

Using the invert operator (A2B), the gamut mapping script and the absolute colorimetric look-up table are used to determine the gamut parameters. In step 350, the gamut mapping evaluator is applied to each entry of the B2A look-up table. The invert object on the B2A is applied to map the L*a*b color space data points to device coordinates (step 360). Once the invert object is applied to the device-independent to device-dependent (B2A) look-up table, an output image using the created gamut matching configuration file is output (step 380). Although described with respect to a printer, a similar procedure known to those skilled in the art could be used for a monitor.

The previous steps are typical in forming a color profile. The actions that occur in step 340 are of particular interest. In setting up the gamut mapping evaluation object, the user defines a gamut mapping evaluator that is used to transform the independent color space values such as CIE L*a*b, CIE LUV, CIE CAM02 Jab or other independent color spaces.

The gamut mapping evaluation object facilitates configuration of the gamut mapping configuration file before the profile is created. This has at least two benefits. First, it allows the processor to work at the full map precision, e.g., floating point precision. Second, it makes it easier for the color specialist to tune because the color specialist does not have to recompile the software for each iteration.

FIG. 4 illustrates an exemplary process for creating an exemplary look-up table used in a configuration profile that is associated with a output device. As described with respect to FIG. 3 above, a first look-up table (LUT) must be derived that provides the mapping parameters for mapping from a device-dependent color space to a device-independent color space (step 400). This involves determining the inverse of the device profile LUT (the B2A LUT).

In step 420, the user creates an object list via an user interface with a profile creation computer application which can be a text editor. The user generates a document, preferably in XML, that is translated by the profile creation computer application into the .gmc file. Although, the user-created document is described using XML, other languages, such as PERL, interpreted C++, Interactive Basic, Java or any language that is modifiable and extendable, can be used.

A brief description of the XML format will be provided for background purposes. XML is, like its SGML ancestor, a tag structured hierarchical markup language. A tag is denoted between a “<” and “> bracket pair. Each tag has an identifying name and this name is made out of a sequence of printable characters. An example of a valid tag could be <phonenumber>.

A tag can have content and in XML there are two ways to specify the content. The first is by bracketing the content by a start-tag and end-tag pair as follows:

<tagname>
content
</tagname>

The “</” marker before the tag name specifies it is the end of the content for the tag with the same name and at the same hierarchy level. The content itself can again be any valid XML markup, including tags or just plain direct content such as text or other content, as long as it consists of text characters.

A second method to define content for a tag is by specifying attributes directly in the tag. These attributes are given as name=“value” pairs directly on the start-tag as follows: <phonenumber tel=“123456789”/>. The attributes do not have to be given on the same line in the document. In fact the following would be perfectly valid also:

<phonenumber
tel=“ 123456789”/>.

### The XML file, regarding the tags, is completely free format, as long as the correct amount of start-tags and end-tags are given.

Both methods of defining content for a tag can be combined, however, the method chosen is defined by the computer application, such as application 100 in FIG. 1. Usually when the content of the tag is itself complex or structured, the first method is used. The attribute method is normally used when the content is simple, and is not more than a few words long.

The identifiers allowed in an XML document, and the content allowed for each tag depends on the application that uses the document. The allowed tags and the content of each tag are typically defined by the schema of the XML document. It is outside the scope of this document to explain schemas; it suffices to say it defines the possible content of XML documents valid for a given application.

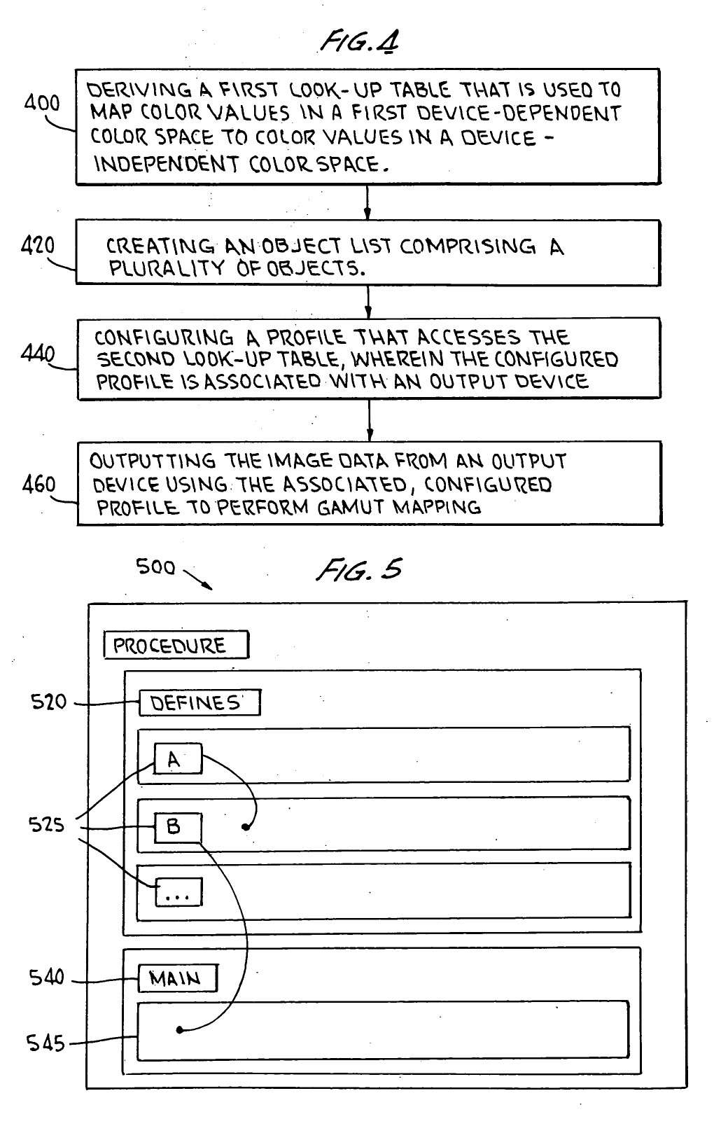

The object list comprises a plurality of objects, some of which are predefined, such as those that perform multiply and divide functions, and others that can be created by the user. The user created objects will be described in more detail with reference to FIG. 5. After creation of the object list, the object list is interpreted by the profile creation application without re-compiling any code. The profile creation application interprets the object list with reference to a configuration object and an output device characterizing LUT to generate a second LUT. The output device characterizing LUT can be derived by measurements, for example, colorimetric measurements, of test patterns, typically color test patterns, output by the device or in case of monitor outputs measured by a spectrometer. The second LUT is used to map the color values in the device-independent color space into a different set of color values within the same device-independent color space, for instance, from one set of LUV values to a second set of LUV values.

A profile is configured that accesses the second LUT and the configured profile is associated with the output device (Step 440). The device profile, typically supplied by the output device manufacturer, is replaced with the configured profile by associating the configured profile with the output device in the operating system of a controlling computer. Of course, the configured profiles are portable files that can be used by a plurality of computers and associated with a number of output devices. This allows a user to develop custom profiles that can be used by a number of the user's output devices.

Using the second LUT in the configured profile, image data is gamut mapped so the input color image data is mapped to the gamut of the output device as specified (Step 460).

In order to construct a gamut mapping evaluator as described in step 440, the color management system defines a set of pre-defined evaluator objects. This set of objects can be viewed as the “machine language” of the gamut mapping. An evaluator in the color management system is defined as an object with the pointwise evaluation member function defined. When a CMS_fObjectGet call routine, which is a software routine performed by the color management system, is executed to obtain the attributes CMS_XEVALDIM, CMS_YEVALDIM or CMS_EVALDIM on the evaluator, a valid value is returned. The routines CMS_XEVALDIM, CMS_YEVALDIM or CMS_EVALDIM are routines that evaluate the color values in the X dimension (CMS_XEVALDIM), the Y dimension (CMS_YEVALDIM) and in intensity (CMS_EVALDIM), and return a value corresponding to the color value in the respective dimension.

In creating an evaluator, the user must define certain procedures which can be given any type of name. The data structure of a procedure will now be described with reference to FIG. 5.

As shown in FIG. 5, a procedure 500 has two well-defined sections: a definition system 520 and the main evaluator or body 540. The definition system 520 is a list of defined functions or blocks 525. The definitions 525 within the definition section may refer to one another in any order—they do not have to be listed in a hierarchical structure. The definitions section object list is a simple list of objects and has therefore no evaluation type, i.e. the type is void. Each of the four International Color Consortium (ICC) rendering intents usually has a dedicated procedure. The procedure 500 can have a general structure in XML format such as:

```
<Procedure InfoCode=“rendering intent”>
    <ObjectList>
      List of defining evaluators.
    </ObjectList>
    <ObjectList Type=“evaluator type”>
      Main body of procedure.
    </ObjectList>
</Procedure>.
```

The main body 540 is a single evaluator. It is populated by the user, who can define or identify from a library objects 545 that will be used to execute the procedure 500. The objects are the portion of the procedure that are executed with reference to the objects 545 and the definition list 520.

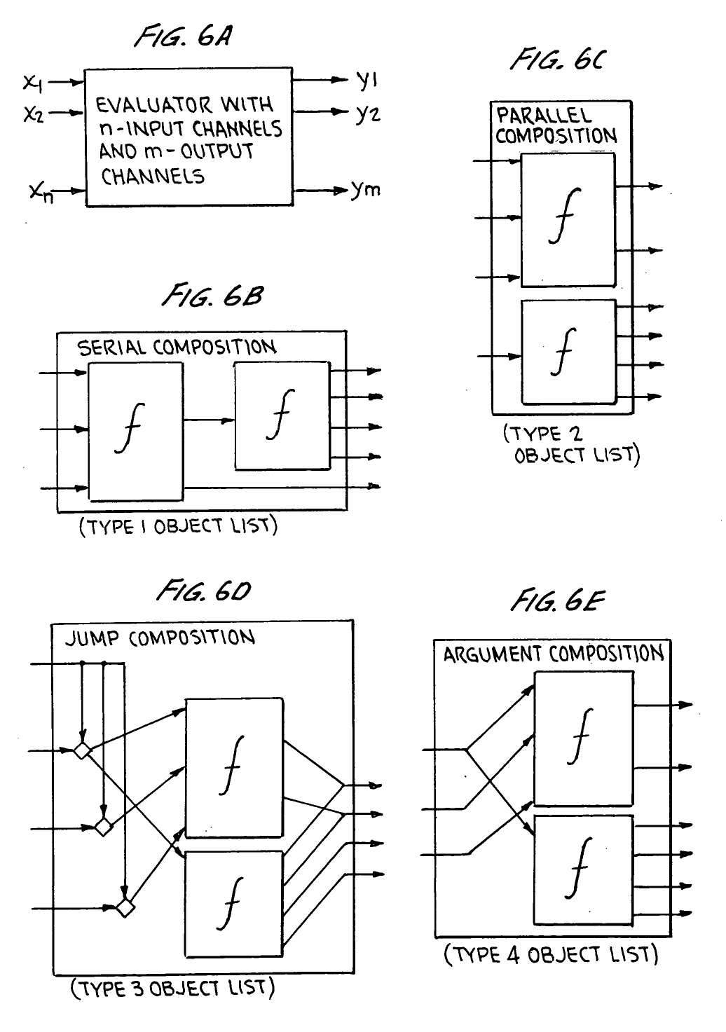

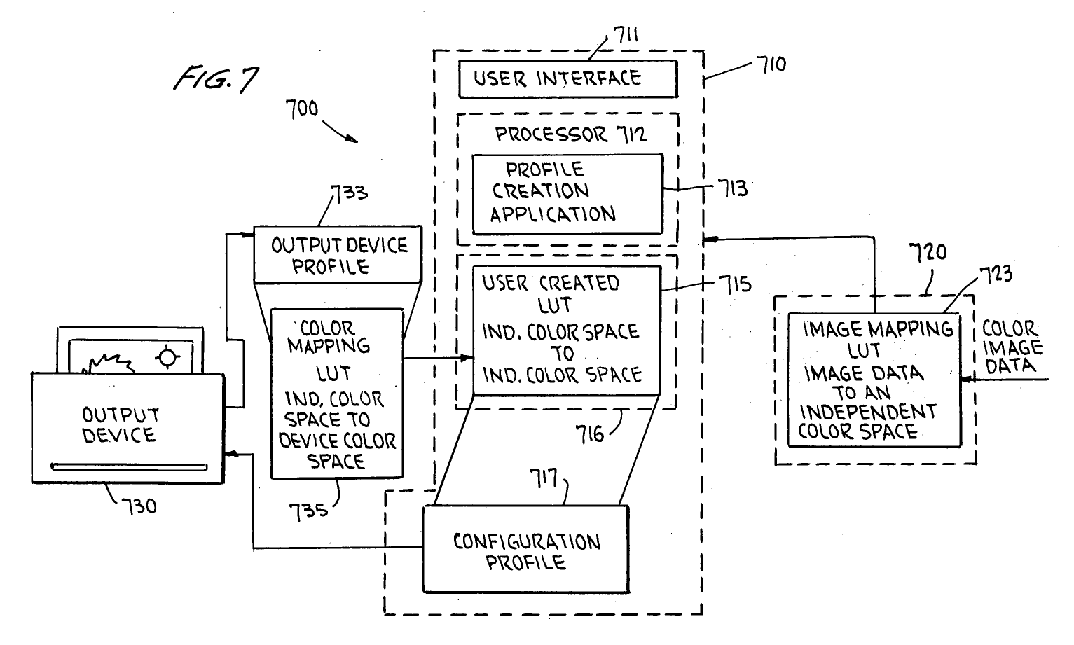

The “building blocks” for creating a gamut mapping evaluation object as described in step 140 is explained in further detail with respect to FIG. 6A.

The purpose of the evaluators, functors and objects is to allow a user to construct a gamut mapping look-up table that provides the desired device-independent to device-dependent mapping to satisfy the user's needs beyond what is available to the consumer presently. Certain evaluators have the typical interpolation constructs and other basic mathematical data types necessary to perform the functions usually associated with gamut mapping (see Appendix, Section 2). Users can use different evaluators within an object list to perform the desired functions to achieve the gamut mapping that the user wants to obtain. For instance, as shown in FIG. 6A, a typical evaluator has n-input channels and m-output channels. The inputs and outputs, in this case, are floating point values representing respective color values. Of course, values of less precision can be used. Evaluators can take in a predetermined number of n-inputs and output a predetermined number of m-outputs. The values m and n are integer values, and do not have to be equal.

A special evaluator is called a functor in the color management system. A functor has a specific pre-defined pointwise evaluation function. A list of pre-defined point wise evaluation functors having a unique identifier is shown in Section 1 of the Appendix. Each of these pre-defined pointwise evaluation functions has a unique identifier so that the functor can be serialized. Functors are written as follows:

<Functor

FunctorlD=“functor name” XDim=“value” YDim=“value”>. The “functor name” can be any of the functor names that are listed in the Color Management System or Image Management System (CMS/IMS) library or those created by a user. For instance, the variables XDim and YDim in the functor name above give respectively the x-dimension and y-dimension of the functor. If any of these two dimensions is fixed for a given functor then it is not necessary to specify this dimension as attribute. However, when a dimension is variable for the functor the dimension is required. The result of the functor, and by extension the containing procedure, will be unpredictable if in this case the dimension is not given as attribute.

The evaluators in the defining section of a procedure must have a unique name identifying the evaluator so that it can be referred to by a “call” functor in the remainder of the procedure. This name is given by an InfoText attribute for the evaluator. For example: <ObjectList Type=“l” InfoText=“MagentaShift”>

This defines a serial evaluator, which will be described in more detail with respect to FIG. 6B, with the name “Magentashift”. The call functor would refer to this evaluator by also using this name as InfoText attribute. For example: <Functor FunctorlD=“Call”]InfoText=“Magentashift”/>.

As shown in FIG. 6B, the evaluators can be constructed as a serial composition (illustrated as a Type 1 object list in the software appendix) in which the output of the first evaluator becomes the input of the second evaluator and so on.

Alternatively, a parallel composition (illustrated as a Type 2 object list in the software appendix), as shown in FIG. 6C, operates by stacking evaluators one below the other, resulting in an evaluator that has the sum of the x-dimensions and a sum of the y-dimensions as x and y, respectively. For instance, the parallel composition (illustrated as a Type 2 object list in the software appendix) shown in FIG. 6C would give a [4, 6] evaluator. In addition, a first channel can alter the final result of the jump composition (illustrated as a Type 3 object list, if used, in the software appendix) as shown in FIG. 6D.

Finally, a fourth composition (illustrated as a Type 4 object list, if used, in the software appendix), the argument composition, as shown in FIG. 6E, is suitable when functions need to be performed a number of times, and the function performed within each block of the argument composition works to create an output based on each of the evaluators.

The above described procedure implements an exemplary gamut mapping configuration (.gmc) file, which follows an XML format. There is, however, no formal schema defined for the format. Nevertheless, most XML editors will be able to open and modify a .gmc file. The possible content of a .gmc file includes possible tag identifiers in a .gmc file that represent types of the objects used in CMS/IMS library.

The enclosing tag for the whole document of a gmc file, or any of the XML files for the CMS/IMS library, is

<MTI
ID=“ id-string”
Format Version=“ format-string”
FileVersion=“file-string”>

All the attribute strings are of the form “number.number” and specify an identify string, the version of the format used and the version of the file. The version of the file can be anything, but both the ID and FormatVersion are fixed for a particular version of the CMS/IMS library

The content of the Meta-Type Information, or <MTI>, tag in a .gmc file is an object list that looks as follows:

```
<ObjectList
  InfoCode= “GamutMapping”
  UseText=“Name of gamut mapping”>
```

An object list with this specific “GamutMapping” as InfoCode value means this object list contains a list of gamut mappings. The UseText is an informational string which is shown by the profile creation when listing the available .gmc files. An Example of a .gmc file is shown in Section 2. of the Appendix.

Also shown by the profile creation is the “Icon” object in the “GamutMapping” object list. This object is of type “Generic” and must have a “Size” attribute that gives the size, in bytes, of the content. The content of this object is the raw RGB 24-bit image of an icon that is shown to display the .gms file.

A purpose of a “GamutMapping” object, for example, is to enclose the various gamut mapping procedure objects. These procedure objects are specified as follows:

<Procedure InfoCode=“rendering intent”>. The rendering intent attribute is one of the following three values:
“RelativeColorimetricMapping”
“PerceptualMapping”
“Saturation.Mapping”.

This attribute specifies the target rendering intent of the procedure. Only one procedure is allowed per rendering intent. It is not necessary to specify a procedure for all rendering intents though. When a rendering intent is missing from a gamut mapping, the CMS/IMS library will typically fall back to its default gamut mapping procedure for that rendering intent.

A procedure has two object lists: the first object list is the definition section, the second is the main evaluator. So in general the structure of a procedure looks like:

```
<Procedure InfoCode=“rendering intent”>
    <ObjectList>
        List of defining evaluators.
    </ObjectList>
    <ObjectList Type=“evaluator type”>
        Main body of procedure.
    </ObjectList>
  <Procedure>
```

Gamut mapping procedures can interact with its calling mechanism inside the CMS/IMS library. The interaction with the CMS/IMS library is based on the value of certain value functors. These values can either communicate information from the gamut mapping procedure to the CMS/IMS library, in which case a value must be given, or vice versa, the CMS/IMS library can set the value of the functor before running the gamut mapping procedure.

Currently the following values are defined as parameters set by the CMS/IMS library and communicated to the gamut mapping procedure:
DstWhite: Luv value
DstBlack: Luv value
DstRed: Lch value
DstGreen: Lch value
DstBlue: Lch value
DstCyan: Lch value
DstMagenta: Lch value
DstYellow: Lch value

The following parameters are communicated back to the CMS/IMS library:
SrcWhite: Luv value of the source white-point.
SrcBlack: Luv value of the source black-point.
SrcRed: Lch value of source red.
SrcBlue: Lch value of source blue
SrcCyan: Lch value of source cyan.
SrcMagenta: Lch value of source magenta
SrcYellow: Lch value of source yellow.

A system for implementing the above described process and procedures is explained in more detail with reference to FIG. 7. The system 700 comprises a computer 710, a profile creation application 713, which can be accessed via processor 712 within computer 710. The profile creation application 713 can be hosted on the computer 710 or external from the computer, on a network server, for example. A hard disc 715 within computer 710 can be used to store output from the profile creation application 713, such as LUTs, profiles, procedures and object lists. Input device 720 receives color image data, either as input from another device or by scanning a color document. A LUT is used to map the color image data from the image data to a device-independent color space, e.g., CIE LUV, CIE LAB, if the image data is not already represented in a device-independent color space. The profile created using the profile creation application 713 is configured as configuration object 717. The configuration object 717 containing the created profile is associated with the output device 730 to allow output of an image having the colorimetric properties determined by the user within the color gamut capabilities of the output device 730.

The computer 710 derives a first look-up table that is used to convert a first device-dependent color space into a device-independent color space by determining an invert operator to translate the color mapping LUT 735 in the output device profile 733. The invert operator allows the generation of an independent color space-to-independent color space LUT 715.

The user via a user interface 711 uses the profile creation application 713 to create an object list comprising a plurality of objects. The object list is interpreted by a profile creation application 713 with reference to a configuration object 717 to generate a second look-up table 715 that is used to convert the device-independent color space into a different set of values within the same device-independent color space. The second look-up table is stored in hard disc 716. Of course, the hard disc 716 is an example of a storage means, and any suitable storage means can be used.

The profile creation application 713 can be executed on a Macintosh computer from Apple or a Microsoft Windows-based computer, for example.

The output device 730 using the profile of the associated configuration object 717 to perform gamut mapping outputs the image data from an output device.

It will be appreciated by those of ordinary skill in the art that the present invention can be embodied in other forms without departing from the spirit or essential characteristics thereof. The foregoing description is therefore considered to be illustrative, and not restrictive. The scope of the invention is indicated by the following claims, and all changes that come within the meaning and range of equivalents are therefore intended to be embraced therein.

What is claimed is:

1. A method for configuring a color management system profile used to gamut map image data to the gamut capabilities of an output device, comprising:
deriving a first look-up table that is used to map color values in a first device-dependent color space to color values in a device-independent color space;
creating an object list comprising a plurality of objects, wherein the object list is interpreted by a computer application with reference to a configuration object to generate a second look-up table that is used to map the color values in the device-independent color space into a different set of color values within the same device-independent color space;
storing the second look-up table;
configuring a profile that accesses the second look-up table, wherein the configured profile is associated with an output device;
performing gamut mapping using the associated, configured profile on the image data; and
outputting the gamut mapped image data to an output device.

2. The method of claim 1, wherein the creating the object list comprises:
accessing a user interface; and
building a procedure by inserting object lists that are interdependent and arranged in a non-hierarchical structure.

3. The method of claim 2, wherein the procedure performs a particular function in the generation of the second look-up table.

4. A computer product stored on a computer-readable medium for configuring a color management system profile used to gamut map image data to the gamut capabilities of an output device, the computer product causing a computer to perform the steps of:
deriving a first look-up table that is used to map colors values in a first device-dependent color space to color values in a device-independent color space;
creating, based on input from a user, an object list comprising a plurality of objects, wherein the object list is interpreted by a computer application with reference to a configuration object to generate a second look-up table that is used to map colors values in the device-independent color space to a different set of color values within the same device-independent color space;
storing the second look-up table;
configuring a profile that accesses the second look-up table, wherein the configured profile is associated with an output device;
performing gamut mapping using the associated, configured profile on the image data; and
outputting the gamut mapped image data to an output device.

5. An apparatus for configuring a color management system profile used to gamut map image data to the gamut capabilities of an output device comprising:
means for deriving a first look-up table that is used to map colors values in a first device-dependent color space to color values in a device-independent color space;
means for creating, based on input from a user, an object list comprising a plurality of objects, wherein the object list is interpreted by a computer application with reference to a configuration object to generate a second look-up table that is used to map colors values in the device-independent color space to a different set of color values within the same device-independent color space;
storage means for storing the second look-up table;
means for configuring a profile that accesses the second look-up table, wherein the configured profile is associated with an output device; and
gamut mapping means for performing gamut mapping using the associated, configured profile on the image data; and
an output means for outputting the gamut mapped image data to an output device.
